(19) United States
(12) Patent Application Publication
(10) Pub. No.: US 2010/0068472 A1
(43) Pub. Date: Mar. 18, 2010

(54) Yellow Azo Dyes for Ink Jet Printing

(76) Inventors: Gavin Wright, Manchester (GB); Rachel Anne James, Manchester (GB); Roy Bradbury, Merseyside (GB); Lynn Patricia Bradbury, Merseyside (GB)

Correspondence Address: MORGAN LEWIS & BOCKIUS LLP, 1111 PENNSYLVANIA AVENUE NW, WASHINGTON, DC, 20004, US

(21) Appl. No.: 12/083,840

(22) PCT Filed: Oct. 13, 2006
(86) PCT No.: PCT/GB2006/003808

§ 371 Date: Mar. 13, 2009

(30) Foreign Application Priority Data
Oct. 22, 2005 (GB) 0521546.2

(51) Int. Cl. B32B 3/10; B05D 5/00; C09D 11/00; C09B 29/36; C09B 31/14

(52) U.S. Cl. 428/195.1; 427/256; 106/31.48; 534/781; 534/780; 534/758

(57) ABSTRACT

Monomers and dimers of mono-azo compounds of formula

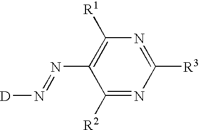

wherein:
D is an optionally substituted aryl or an optionally substituted heteroaryl group;
R¹ and R² are each independently optionally substituted alkyl: halo: amino: —NR⁴R⁵; wherein R⁴ is H, optionally substituted alkyl, optionally substituted alkoxy, optionally substituted acyl, optionally substituted aryl, optionally substituted heterocyclyl; and R⁵ is optionally substituted alkyl, optionally substituted alkoxy, optionally substituted acyl, optionally substituted aryl, optionally substituted heterocyclyl or R⁴ together with R⁵ and the nitrogen to which they are attached forms an optionally substituted 5 or 6 membered ring: —OR⁶; wherein R⁶ is H or optionally substituted alkyl: or —SR⁷; wherein R⁷ is optionally substituted alkyl;
R³ is amino: halo; —NR⁴R⁵; wherein R⁴ is H, optionally substituted alkyl, optionally substituted alkoxy, optionally substituted acyl, optionally substituted aryl, optionally substituted heterocyclyl; and R⁵ is optionally substituted alkyl, optionally substituted alkoxy, optionally substituted acyl, optionally substituted aryl, optionally substituted heterocyclyl or R⁴ together with R⁵ and the nitrogen to which they are attached forms an optionally substituted 5 or 6 membered ring: hydroxy: —OR⁶; wherein R⁶ is H or optionally substituted alkyl: or —SR⁷; wherein R⁷ is optionally substituted alkyl. Also compositions, inks and ink-jet cartridges containing these compounds and ink-jet printing processes using these compounds.

This invention relates to ink-jet printing processes, compounds, compositions and inks, to printed substrates and to ink-jet printer cartridges.

Ink-jet printing is a non-impact printing technique in which droplets of ink are ejected through a fine nozzle onto a substrate without bringing the nozzle into contact with the substrate. The set of inks used in this technique typically comprise yellow, cyan, magenta and black inks.

With the advent of high-resolution digital cameras and ink-jet printers it is becoming increasingly common for consumers to print off photographs using an ink-jet printer. This avoids the expense and inconvenience of conventional silver halide photography.

While ink-jet printers have many advantages over other forms of printing and image development there are still technical challenges to be addressed. For example, there are the contradictory requirements of providing ink colorants that are soluble in the ink medium and yet do not run or smudge excessively when printed on paper. The inks need to dry quickly to avoid sheets sticking together after they have been printed, but they should not form a crust over the tiny nozzle used in the printer. Storage stability is also important to avoid particle formation that could block the tiny nozzles used in the printer especially since consumers can keep an ink-jet ink cartridge for several months. Furthermore, and especially important with photographic quality reproductions, the resultant images should not fade rapidly on exposure to light or common oxidising gases such as ozone. One of the key factors in determining colour appearance of an ink-jet print is the chroma intensity of the component colours and small changes in this can have a profound impact on the quality of the image, this is especially true when the image is a photographic reproduction.

There are many thousands of known colorants and few have the characteristics which enable them to be used in ink-jet inks.

We have found that certain azo 1,3-pyrimidine compounds provide yellow colorants which are particularly suitable for use in ink-jet printing.

According to the present invention there is provided a process for printing an image on a substrate by means of an ink-jet printer which comprises applying thereto a composition comprising a liquid medium and a mono-azo compound of Formula (1), and salts thereof, or a dimer of said mono-azo compound of Formula (2), and salts thereof:

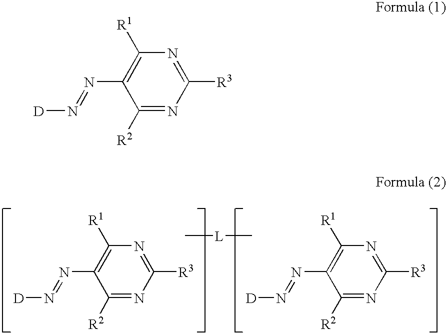

wherein:
D is an optionally substituted aryl or an optionally substituted heteroaryl group;
R¹ and R² are each independently optionally substituted alkyl: halo: amino: —NR⁴R⁵; wherein R⁴ is H, optionally substituted alkyl, optionally substituted alkoxy, optionally substituted acyl, optionally substituted aryl, optionally substituted heterocyclyl; and R⁵ is optionally substituted alkyl, optionally substituted alkoxy, optionally substituted acyl, optionally substituted aryl, optionally substituted heterocyclyl or R⁴ together with R⁵ and the nitrogen to which they are attached forms an optionally substituted 5 or 6 membered ring: —OR⁶; wherein R⁶ is H or optionally substituted alkyl: or SR⁷; wherein R⁷ is optionally substituted alkyl;
R³ is amino: halo; —NR⁴R⁵; wherein R⁴ is H, optionally substituted alkyl, optionally substituted alkoxy, optionally substituted acyl, optionally substituted aryl, optionally substituted heterocyclyl; and R⁵ is optionally substituted alkyl, optionally substituted alkoxy, optionally substituted acyl, optionally substituted aryl, optionally substituted heterocyclyl or R⁴ together with R⁵ and the nitrogen to which they are attached forms an optionally substituted 5 or 6 membered ring: hydroxy: —OR⁶; wherein R⁶ is H or optionally substituted alkyl: or —SR⁷; wherein R⁷ is optionally substituted alkyl; and
L is a divalent linking group that is covalently attached to D, R¹ or R³.

The ink-jet printer preferably applies the ink to the substrate in the form of droplets that are ejected through a small orifice onto the substrate. Preferred ink-jet printers are piezoelectric ink-jet printers and thermal ink-jet printers. In thermal ink-jet printers, programmed pulses of heat are applied to the ink in a reservoir by means of a resistor adjacent to the orifice, thereby causing the ink to be ejected from the orifice in the form of small droplets directed towards the substrate during relative movement between the substrate and the orifice. In piezoelectric ink-jet printers the oscillation of a small crystal causes ejection of the ink from the orifice. Alternately the ink can be ejected by an electromechanical actuator connected to a moveable paddle or plunger, for example as described in International Patent Application WO00/48938 and International Patent Application WO00/55089.

The substrate is preferably paper, plastic, a textile, metal or glass, more preferably paper, an overhead projector slide or a textile material, especially paper.

Preferred papers are plain, treated or coated papers which may have an acid, alkaline or neutral character. Glossy papers are especially preferred.

Examples of commercially available treated papers include HP Premium Coated Paper, HP Photopaper™ (both available from Hewlett Packard Inc.); Stylus™ Pro 720 dpi Coated Paper, Epson Photo Quality™ Glossy Film, Epson Photo Quality™ Glossy Paper (all available from Seiko Epson Corp.); Canon HR 101 High Resolution™ Paper, Canon GP 201 Glossy™ Paper, Canon HG 101 and HG201 High Gloss™ Film, Canon PR101 (all available from Canon); Kodak Premium™ Photopaper, Kodak Premium™ InkJetpaper (available from Kodak); Konica Inkjet Paper QP™ Professional Photo Glossy, Konica Inkjet Paper QP™ Professional Photo 2-sided Glossy, Konica Inkjet Paper QP™ Premium Photo Glossy, Konica Inkjet Paper QP™ Premium Photo Silky (available from Konica).

Compounds of Formula (2), and salts thereof, are preferably of Formulae, (3) to (5), and salts thereof:

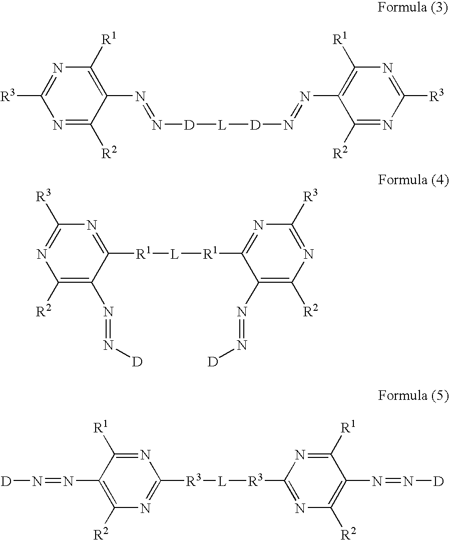

wherein D, L, R¹, R² and R³ are as hereinbefore defined.

When L is linked through any one of D, R¹ or R³ in any one of Formulae (2) to (5) then the D, R¹ or R³ linking group will be the divalent radical of any of the groups described below for D, R¹ and R³.

Preferably when D is optionally substituted aryl it is optionally substituted phenyl or optionally substituted napthyl or when D is bound to the linking group, L, it is the equivalent divalent radical.

When D is optionally substituted heteroaryl it is preferably selected from the group consisting of the following: optionally substituted pyrrolyl, optionally substituted furyl, optionally substituted thienyl, optionally substituted pyrazolyl, optionally substituted imidazolyl, optionally substituted triazolyl, optionally substituted thiazolyl, optionally substituted thiadiazolyl, optionally substituted pyridyl, optionally substituted pyrimidyl or optionally substituted pyrazinyl or when D is bound to the linking group, L, it is the equivalent divalent radical.

Preferably D carries at least one water solubilising group, especially an acid group and more especially at least one group selected from —SO₃H, —CO₂H or —PO₃H₂. The water solubilising group may be bound directly to the optionally substituted aryl or optionally substituted heteroaryl ring or it may be carried on another substituent, preferably the water solubilising group is bound directly to the aryl or heteroaryl ring.

More preferably D is optionally substituted phenyl or optionally substituted napthyl carrying at least one substituent selected from the group consisting of —SO₃H, —CO₂H especially —SO₃H or when D is bound to the linking group, L, it is the equivalent divalent radical.

Most preferably D is optionally substituted phenyl or optionally substituted napthyl carrying 1 to 3 —SO₃H substituents and especially phenyl carrying 2 —SO₃H substituents or when D is bound to the linking group, L, it is the equivalent divalent radical.

Examples of preferred phenyl and naphthyl groups represented by D are 2,5-disulfophenyl, 1,3,6-trisulfo-7-naphthyl, 2-sulfo-4-methoxyphenyl and 4-sulfophenyl or when D is bound to the linking group, L, it is the equivalent divalent radical.

R¹ and R² are preferably each independently: halo, especially fluoro or chloro; amino; —NR⁴R⁵; wherein R⁴ is H, optionally substituted C₁₋₄alkyl, optionally substituted C₁₋₄alkoxy, optionally substituted C₁₋₄acyl, optionally substituted phenyl, especially phenyl substituted with at least one substituent selected from the group consisting of —SO₃H, —CO₂H, —PO₃H₂, optionally substituted heterocyclyl; and R⁵ is optionally substituted C₁₋₄alkyl, optionally substituted C₁₋₄alkoxy, optionally substituted C₁₋₄acyl, optionally substituted phenyl especially phenyl substituted with at least one substituent selected from the group consisting of —SO₃H, —CO₂H, —PO₃H₂, optionally substituted heterocyclyl or R⁴ together with R⁵ and the nitrogen to which they are attached forms an optionally substituted 5 or 6 membered ring: —OR⁶; wherein R⁶ is H or optionally substituted C₁₋₄alkyl: or —SR⁷; wherein R⁷ is C₁₋₄alkyl. When R¹ is bound to the linking group, L, it is preferably the equivalent divalent radical of those groups listed above.

It is especially preferred that R¹ and R² are each independently: chloro; amino; NHR⁵ wherein R⁵ is optionally substituted C₁₋₄alkyl, optionally substituted C₁₋₄acyl, phenyl substituted with at least one substituent selected from the group consisting of —SO₃H and —CO₂H or —OR⁶; wherein R⁶ is H or optionally substituted C₁₋₄alkyl or when R¹ is bound to the linking group, L, it is the equivalent divalent radical.

R³ is preferably amino; —NR⁴R⁵; wherein R⁴ is H, optionally substituted C₁₋₄alkyl, optionally substituted C₁₋₄alkoxy, optionally substituted C₁₋₄acyl, optionally substituted phenyl, especially phenyl substituted with at least one substituent selected from the group consisting of —SO₃H, —CO₂H, —PO₃H₂, optionally substituted heterocyclyl; and R⁵ is optionally substituted C₁₋₄alkyl, optionally substituted C₁₋₄alkoxy, optionally substituted C₁₋₄acyl, optionally substituted phenyl especially phenyl substituted with at least one substituent selected from the group consisting of —SO₃H, —CO₂H, —PO₃H₂, optionally substituted heterocyclyl or R⁴ together with R⁵ and the nitrogen to which they are attached forms an optionally substituted 5 or 6 membered ring: —OR⁶; wherein R⁶ is H or optionally substituted C₁₋₄alkyl: or —SR⁷; wherein R⁷ is optionally substituted C₁₋₄alkyl. When R³ is bound to the linking group, L, preferably it is the equivalent divalent radical of any of those groups listed above.

More preferably R³ is amino; —NR⁴R⁵, wherein R⁴ is H or optionally substituted C₁₋₄alkyl and R⁵ is optionally substituted C₁₋₄alkyl; —OR⁶, wherein R⁶ is H or optionally substituted C₁₋₄alkyl; or —SR⁷, wherein R⁷ is optionally substituted C₁₋₄alkyl or when R³ is bound to the linking group, L, it is the equivalent divalent radical.

When the process utilises a dimer of Formula (2) and salts thereof then the two mono-azo compounds of Formula (1) may be the same or different, preferably they are the same.

L is preferably selected from the group consisting of: optionally substituted alkylene; optionally substituted arylene; optionally substituted cycloalkenylene, and optionally substituted heterocyclylene (including optionally substituted heteroarylene); —CO—; —NHCONH—; a group of formula: —CO—R⁹—CO—; —CO—NH—R⁹—NH—CO—; —SO₂—R⁹—SO₂—; —SO₂—NH—R⁹—NH—SO₂—; or —NR¹⁰—R⁹—NR¹⁰—; wherein R⁹ is alkylene or arylene optionally bearing substituents selected from the group consisting of alkoxy, sulfo, carboxy, hydroxy and amino and R¹⁰ is H, alkyl, aryl or heterocyclyl optionally bearing a substituent preferably selected from the group comprising alkoxy, sulfo, carboxy, hydroxy and amino.

In one preferred embodiment L comprises one or more groups of formula:

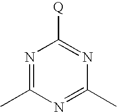

wherein: Q is NR¹¹R¹², SR¹¹ or OR¹¹ and R¹¹ and R¹² are independently H, optionally substituted alkyl, optionally substituted aryl or optionally substituted heterocyclyl where the substituent is preferably selected from the group consisting of alkoxy, amino, sulfo, carboxy, hydroxy and amino.

Optional substituents which may be present on R¹, R², R³, R⁴, R⁵, R⁶, R⁷, R⁸, R⁹, R¹⁰, R¹¹ and R¹², D or L may be independently selected from: optionally substituted alkyl (preferably C₁₋₄-alkyl), optionally substituted alkoxy (preferably C₁₋₄-alkoxy), optionally substituted aryl (preferably phenyl), optionally substituted aryloxy (preferably phenoxy), optionally substituted heterocyclyl, polyalkylene oxide (preferably polyethylene oxide or polypropylene oxide), carboxy, phosphato, nitro, cyano, halo, ureido, —SO₂F, hydroxy, ester, —NR^{a}R^{b}, —COR^{a}, —CONR^{a}R^{b}, —NHCOR^{a}, carboxyester, sulfone, and —SO₂NR^{a}R^{b}, wherein R^{a} and R^{b} are each independently H or optionally substituted alkyl (especially C₁₋₄-alkyl). Optional substituents for any of the substituents described above may be selected from the same list of substituents.

Preferred optional substituents on any of R¹ to R¹², D or L are preferably selected from —OH, alkyl, carboxy, sulfo and —CN.

Compounds of Formula (1), and salts thereof, and of Formula (2), and salts thereof, are preferably free from fibre reactive groups. The term fibre reactive group is well known in the art and is described for example in EP 0356014 A1. Fibre reactive groups are capable, under suitable conditions, of reacting with the hydroxyl groups present in cellulosic fibres or with the amino groups present in natural fibres to form a covalent linkage between the fibre and the dye. As examples of fibre reactive groups preferably not present in the compounds of the first aspect of the present invention there may be mentioned aliphatic sulfonyl groups which contain a sulfate ester group in the beta-position to the sulfur atom, e.g. beta-sulfato-ethylsulfonyl groups, alpha, beta-unsaturated acyl radicals of aliphatic carboxylic acids, for example acrylic acid, alpha-chloro-acrylic acid, alpha-bromoacrylic acid, propiolic acid, maleic acid and mono- and dichloro maleic; also the acyl radicals of acids which contain a substituent which reacts with cellulose in the presence of an alkali, e.g. the radical of a halogenated aliphatic acid such as chloroacetic acid, beta-chloro and beta-bromopropionic acids and alpha, beta-dichloro- and dibromopropionic acids or radicals of vinylsulfonyl- or beta-chloroethylsulfonyl- or beta-sulfatoethyl-sulfonyl-endo-methylene cyclohexane carboxylic acids. Other examples of cellulose reactive groups are tetrafluorocyclobutyl carbonyl, trifluoro-cyclobutenyl carbonyl, tetrafluorocyclobutylethenyl carbonyl, trifluoro-cyclobutenylethenyl carbonyl; activated halogenated 1,3-dicyanobenzene radicals; and heterocyclic radicals which contain 1, 2 or 3 nitrogen atoms in the heterocyclic ring and at least one cellulose reactive substituent on a carbon atom of the ring.

When compounds of Formula (1) or Formula (2) are in the form of a salt the preferred salts are alkali metal salts (especially lithium, sodium and potassium salts), ammonium and substituted ammonium salts and mixtures thereof. Especially preferred salts are sodium, potassium and lithium salts, salts with ammonia and volatile amines and mixtures thereof.

The compounds may be converted into a desired salt using known techniques. For example, an alkali metal salt of a compound may be converted into the ammonium or substituted ammonia salt by dissolving an alkali metal salt of the compound in water, acidifying with a mineral acid and adjusting the pH of the solution to pH 9 to 9.5 with ammonia or the amine and removing the alkali metal cations by dialysis or by use of an ion exchange resin.

The compounds of Formula (1), and salts thereof, and Formula (2), and salts thereof, as described herein, may exist in tautomeric forms other than those shown in this specification. These tautomers are also included within the scope of the present inventions.

The compounds of Formula (1), and salts thereof, and Formula (2), and salts thereof, have attractive, strong yellow or orange shades, especially yellow, and are valuable colorants for use in the preparation of ink-jet printing inks. They benefit from a good balance of solubility, storage stability and fastness to water and light.

The compounds of Formula (1) may be prepared by diazotising a compound of formula D-NH₂, wherein D is as hereinbefore defined, to give a diazonium salt and coupling the resultant diazonium salt with a compound of Formula (6) wherein R¹, R² and R³ are as hereinbefore defined:

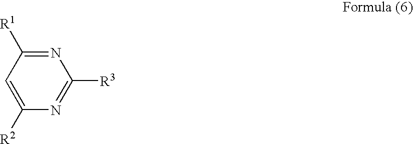

When L is a divalent linker covalently attached to D then the compounds of Formula (2) may be prepared by tetrazotising a compound of the Formula (7) wherein D and L are as hereinbefore defined to give a bis-diazonium salt and coupling the resultant bis-diazonium salt with a compound of Formula (6) wherein R¹, R² and R³ are as hereinbefore defined:

H₂N-D-L-D-NH₂ Formula (7)

When L is a divalent linker covalently attached to R¹ (or by an analogous process when L is attached to R²) the compounds of Formula (2) may be prepared by diazotising a compound of formula D-NH₂ wherein D is as hereinbefore defined to give a diazonium salt and coupling the resultant diazonium salt with a compound of Formula (8) wherein R¹, R² and R³ are as hereinbefore defined:

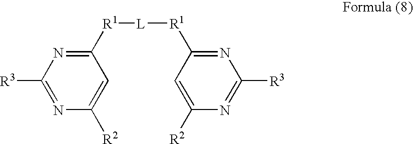

When L is a divalent linker covalently attached to R³ the compounds of Formula (2) may be prepared by diazotising a compound of formula D-NH₂ wherein D is as hereinbefore defined to give a diazonium salt and coupling the resultant diazonium salt with a compound of Formula (9) wherein R¹, R² and R³ are as hereinbefore defined:

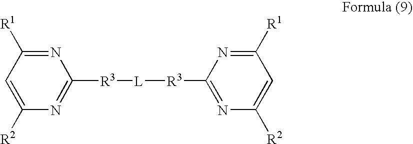

Compounds of Formula (7) wherein L comprises a triazine and D is an aryl group may be prepared, by way of example; by the condensation of two equivalents of a suitable aryl diamine compound with one equivalent of cyanuric chloride followed by the reaction of the resultant mono chloro compound with a compound of formula QH, wherein Q is as hereinbefore defined.

Compounds of Formula (8) wherein L comprises an alkylene group may be prepared, by way of example, by the condensation of two equivalents of an optionally substituted pyrimidine compound wherein R¹ (or R²) comprises chloro with one equivalent of a diamino alkane.

Compounds of Formula (9) wherein L comprises an alkylene group may be prepared, by way of example, by the condensation of two equivalents of an optionally substituted pyrimidine compound wherein R³ comprises a thiol group with one equivalent of a dibromo alkane.

All diazotisation are preferably performed at a temperature of 0° C. to 10° C. Preferably diazotisations are performed in water, preferably at a pH below 7. Dilute mineral acid, e.g. HCl or H₂SO₄, may be used to achieve the desired pH conditions.

Reaction conditions are those generally used in the dyestuff art, for example as described in EP 0356080.

The liquid medium may comprise water, a mixture of water and organic solvent or organic solvent free from water.

Preferably the liquid medium comprises a mixture of water and organic solvent or organic solvent free from water.

When the liquid medium comprises a mixture of water and organic solvent, the weight ratio of water to organic solvent is preferably from 99:1 to 1:99, more preferably from 99:1 to 50:50 and especially from 95:5 to 80:20.

It is preferred that the organic solvent present in the mixture of water and organic solvent is a water-miscible organic solvent or a mixture of such solvents. Preferred water-miscible organic solvents include C₁₋₆-alkanols, preferably methanol, ethanol, n-propanol, isopropanol, n-butanol, sec-butanol, tert-butanol, n-pentanol, cyclopentanol and cyclohexanol; linear amides, preferably dimethylformamide or dimethylacetamide; ketones and ketone-alcohols, preferably acetone, methyl ether ketone, cyclohexanone and diacetone alcohol; water-miscible ethers, preferably tetrahydrofuran and dioxane; diols, preferably diols having from 2 to 12 carbon atoms, for example pentane-1,5-diol, ethylene glycol, propylene glycol, butylene glycol, pentylene glycol, hexylene glycol and thiodiglycol and oligo- and poly-alkyleneglycols, preferably diethylene glycol, triethylene glycol, polyethylene glycol and polypropylene glycol; triols, preferably glycerol and 1,2,6-hexanetriol; mono-C₁₋₄-alkyl ethers of diols, preferably mono-C₁₋₄-alkyl ethers of diols having 2 to 12 carbon atoms, especially 2-methoxyethanol, 2-(2-methoxyethoxy)ethanol, 2-(2-ethoxyethoxy)-ethanol, 2-[2-(2-methoxyethoxy)ethoxy]ethanol, 2-[2-(2-ethoxyethoxy)-ethoxy]-ethanol and ethyleneglycol monoallylether; cyclic amides, preferably 2-pyrrolidone, N-methyl-2-pyrrolidone, N-ethyl-2-pyrrolidone, caprolactam and 1,3-dimethylimidazolidone; cyclic esters, preferably caprolactone; sulfoxides, preferably dimethyl sulfoxide and sulfolane. Preferably the liquid medium comprises water and 2 or more, especially from 2 to 8, water-miscible organic solvents.

Especially preferred water-miscible organic solvents are cyclic amides, especially 2-pyrrolidone, N-methyl-pyrrolidone and N-ethyl-pyrrolidone; diols, especially 1,5-pentane diol, ethyleneglycol, thiodiglycol, diethyleneglycol and triethyleneglycol; and mono-C₁₋₄-alkyl and C₁₋₄-alkyl ethers of diols, more preferably mono-C₁₋₄-alkyl ethers of diols having 2 to 12 carbon atoms, especially 2-methoxy-2-ethoxy-2-ethoxyethanol.

Examples of further suitable liquid media comprising a mixture of water and one or more organic solvents are described in U.S. Pat. No. 4,963,189, U.S. Pat. No. 4,703,113, U.S. Pat. No. 4,626,284 and EP-A-425,150.

When the liquid medium comprises organic solvent free from water, (i.e. less than 1% water by weight) the solvent preferably has a boiling point of from 30° to 200° C., more preferably of from 40° to 150° C., especially from 50 to 125° C. The organic solvent may be water-immiscible, water-miscible or a mixture of such solvents. Preferred water-miscible organic solvents are any of the hereinbefore-described water-miscible organic solvents and mixtures thereof. Preferred water-immiscible solvents include, for example, aliphatic hydrocarbons; esters, preferably ethyl acetate; chlorinated hydrocarbons, preferably CH₂Cl₂; and ethers, preferably diethyl ether; and mixtures thereof.

When the liquid medium comprises a water-immiscible organic solvent, preferably a polar solvent is included because this enhances solubility of the dye in the liquid medium. Examples of polar solvents include C₁₋₄-alcohols.

In view of the foregoing preferences it is especially preferred that where the liquid medium is organic solvent free from water it comprises a ketone (especially methyl ethyl ketone) and/or an alcohol (especially a C₁₋₄-alkanol, more especially ethanol or propanol).

The organic solvent free from water may be a single organic solvent or a mixture of two or more organic solvents. It is preferred that when the liquid medium is organic solvent free from water it is a mixture of 2 to 5 different organic solvents. This allows a liquid medium to be selected that gives good control over the drying characteristics and storage stability of the ink.

Liquid media comprising organic solvent free from water are particularly useful where fast drying times are required and particularly when printing onto hydrophobic and non-absorbent substrates, for example plastics, metal and glass.

The liquid medium may of course contain additional components conventionally used in ink-jet printing inks, for example viscosity and surface tension modifiers, corrosion inhibitors, biocides, kogation reducing additives and surfactants which may be ionic or non-ionic.

Usually only one colorant of Formula (1) or Formula (2) will be used in the composition. However, different compounds of Formula (1) and/or Formula (2) may be mixed in the composition.

The colorant of Formula (1) or Formula (2) will usually be in the form of a single salt. However mixtures of salts may be used.

Although not usually necessary, further colorants may be added to the composition/ink to modify the shade and performance properties. Examples of such colorants include C.I. Direct Yellow 86, 132, 142 and 173; C.I. Direct Blue 307; C.I. Food Black 2; C.I. Direct Black 168 and 195; C.I. Acid Yellow 23.

Preferred examples of further yellow colorants include: C.I. Direct Yellow 8; C.I. Direct Yellow 11; C.I. Direct Yellow 12; C.I. Direct Yellow 27; C.I. Direct Yellow 28; C.I. Direct Yellow 29; C.I. Direct Yellow 44; C.I. Direct Yellow 50; C.I. Direct Yellow 85; C.I. Acid Yellow 17; C.I. Acid Yellow 19; C.I. Acid Yellow 25; C.I. Acid Yellow 40; C.I. Acid Yellow 42; C.I. Acid Yellow 44; C.I. Acid Yellow 49; C.I. Acid Yellow 61; C.I. Acid Yellow 127; C.I. Acid Yellow 151; C.I. Acid Yellow 199 and C.I. Acid Yellow 219.

It is preferred that the composition according to the invention is ink suitable for use in an ink-jet printer. Ink suitable for use in an ink-jet printer is ink which is able to repeatedly fire through an ink-jet printing head without causing blockage of the fine nozzles.

Ink suitable for use in an ink-jet printer preferably has a viscosity of less than 20 cP, more preferably less than 10 cP, especially less than 5 cP, at 25° C.

The surface tension of the ink is preferably in the range 20-65 dynes/cm, more preferably in the range 30-60 dynes/cm, at 25° C.

Ink suitable for use in an ink-jet printer preferably contains less than 500 ppm, more preferably less than 250 ppm, especially less than 100 ppm, more especially less than 10 ppm in total of divalent and trivalent metal ions (other than any divalent and trivalent metal ions bound to a colorant of Formula (1) or Formula (2) or any other component of the ink).

Preferably ink suitable for use in an ink-jet printer has been filtered through a filter having a mean pore size below 10 μm, more preferably below 3 μm, especially below 2 μm, more especially below 1 μm. This filtration removes particulate matter that could otherwise block the fine nozzles found in many ink-jet printers.

Preferably ink suitable for use in an ink-jet printer contains less than 500 ppm, more preferably less than 250 ppm, especially less than 100 ppm, more especially less than 10 ppm in total of halide, particularly chloride, ions.

Preferred compositions comprise:
(a) from 0.01 to 30 parts of dyes of Formula (1), and salts thereof, and/or Formula (2), and salts thereof; and
(b) from 70 to 99.99 parts of a liquid medium;
   wherein all parts are by weight.

Preferably the number of parts of (a)+(b)=100.

The number of parts of component (a) is preferably from 0.1 to 20, more preferably from 0.5 to 15, and especially from 1 to 5 parts. The number of parts of component (b) is preferably from 80 to 99.9, more preferably from 85 to 99.5 and especially from 95 to 95 parts.

Preferably component (a) is completely dissolved in component (b). Preferably component (a) has a solubility in component (b) at 20° C. of at least 10%. This allows the preparation of liquid dye concentrates that may be used to prepare more dilute inks and reduces the chance of the dye precipitating if evaporation of the liquid medium occurs during storage.

The inks may be incorporated in an ink-jet printer as a high concentration yellow ink, a low concentration yellow ink or both a high concentration and a low concentration ink. In the latter case this can lead to improvements in the resolution and quality of printed images. Thus, the present invention also provides a composition (preferably an ink) where component (a) is present in an amount of 2.5 to 7 parts, more preferably 2.5 to 5 parts (a high concentration ink) or component (a) is present in an amount of 0.5 to 2.4 parts, more preferably 0.5 to 1.5 parts (a low concentration ink).

The pH of the composition is preferably from 4 to 11, more preferably from 7 to 10.

According to a second aspect of the invention there is provided a composition comprising a compound of Formula (1), and salts thereof or Formula (2), and salts thereof, as defined in the first aspect of the invention and a liquid medium which comprises a mixture of water and organic solvent or organic solvent free from water.

In the second aspect of the invention the composition, the compounds and salts of Formula (1) and of Formula (2), the organic solvent in the mixture of water and organic solvent and the organic solvent free from water are as described and preferred in the first aspect of the invention.

Preferably the composition according to the second aspect of the invention is ink suitable for use in an ink-jet printer, as defined in the first aspect of the invention.

According to a third aspect of the invention there is provided a mono-azo compound of Formula (1) and salts thereof:

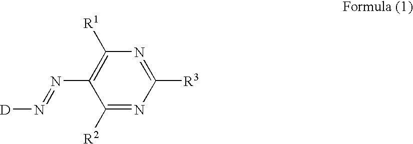

wherein:
D is an optionally substituted aryl or an optionally substituted heteroaryl group;
R¹ and R² are each independently optionally substituted alkyl: halo: amino: —NR⁴R⁵; wherein R⁴ is H, optionally substituted alkyl, optionally substituted alkoxy, optionally substituted acyl, optionally substituted aryl, optionally substituted heterocyclyl; and R⁵ is optionally substituted alkyl, optionally substituted alkoxy, optionally substituted acyl, optionally substituted aryl, optionally substituted heterocyclyl or R⁴ together with R⁵ and the nitrogen to which they are attached forms an optionally substituted 5 or 6 membered ring: —OR⁶; wherein R⁶ is H or optionally substituted alkyl: or —SR⁷; wherein R⁷ is optionally substituted alkyl;
R³ is amino: halo; —NR⁴R⁵; wherein R⁴ is H, optionally substituted alkyl, optionally substituted alkoxy, optionally substituted acyl, optionally substituted aryl, optionally substituted heterocyclyl; and R⁵ is optionally substituted alkyl, optionally substituted alkoxy, optionally substituted acyl, optionally substituted aryl, optionally substituted heterocyclyl or R⁴ together with R⁵ and the nitrogen to which they are attached forms an optionally substituted 5 or 6 membered ring: hydroxy: —OR⁶; wherein R⁶ is H or optionally substituted alkyl: or —SR⁷; wherein R⁷ is optionally substituted alkyl; and
   provided that the compound of Formula (1), and salts thereof, are free from fibre reactive groups.

D, R¹, R² and R³ in the compound of Formula (1), and salts thereof, are as described and preferred in the first aspect of the invention.

A fourth aspect of the invention provides a composition comprising a compound of Formula (1) and salts thereof as defined in the third aspect of the invention and water.

The aqueous compositions are as described and preferred in the first aspect of the invention and the compound of Formula (1) and salts thereof are as described and preferred in the third aspect of the invention.

Preferably the composition according to the fourth aspect of the invention is ink suitable for use in an ink-jet printer, as defined in the first aspect of the invention.

A fifth aspect of the invention provides a dimer of mono-azo compounds of Formula (2) and salts thereof:

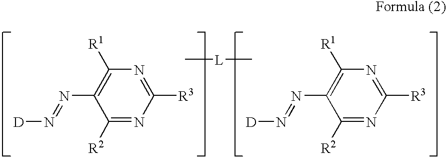

wherein:
D is an optionally substituted aryl or an optionally substituted heteroaryl group;
R¹ and R² are each independently optionally substituted alkyl: halo: amino: —NR⁴R⁵; wherein R⁴ is H, optionally substituted alkyl, optionally substituted alkoxy, optionally substituted acyl, optionally substituted aryl, optionally substituted heterocyclyl; and R⁵ is optionally substituted alkyl, optionally substituted alkoxy, optionally substituted acyl, optionally substituted aryl, optionally substituted heterocyclyl or R⁴ together with R⁵ and the nitrogen to which they are attached forms an optionally substituted 5 or 6 membered ring: —OR⁶; wherein R⁶ is H or optionally substituted alkyl: or —SR⁷; wherein R⁷ is optionally substituted alkyl;
R³ is amino: halo; —NR⁴R⁵; wherein R⁴ is H, optionally substituted alkyl, optionally substituted alkoxy, optionally substituted acyl, optionally substituted aryl, optionally substituted heterocyclyl; and R⁵ is optionally substituted alkyl, optionally substituted alkoxy, optionally substituted acyl, optionally substituted aryl, optionally substituted heterocyclyl or R⁴ together with R⁵ and the nitrogen to which they are attached forms an optionally substituted 5 or 6 membered ring: hydroxy: —OR⁶; wherein R⁶ is H or optionally substituted alkyl: or —SR⁷; wherein R⁷ is optionally substituted alkyl; and

L is a divalent linking group that is covalently attached to D, R¹ or R³.

Preferences for R¹, R², R³, D and L in the compound of Formula (2) and salts thereof in the fifth aspect of the invention are as described in the first aspect of the invention.

A sixth aspect of the invention provides a composition comprising a compound of Formula (2) and salts thereof as defined in the fifth aspect of the invention and water.

Preferably the composition according to the sixth aspect of the invention is ink suitable for use in an ink-jet printer, as defined in the first aspect of the invention.

A seventh aspect of the present invention provides a material preferably paper, plastic, a textile, metal or glass, more preferably paper, an overhead projector slide or a textile material, especially paper more especially plain, coated or treated papers printed with a compound and salts thereof as described in the third and fifth aspects of the invention, a composition as described in the second, fourth or sixth aspect of the invention or by means of a process as described in the first aspect of the invention.

It is especially preferred that the printed material of the fourth aspect of the invention is a print on a photographic quality paper printed by means of a process according to the first aspect of the invention.

An eighth aspect of the present invention provides an ink-jet printer cartridge comprising a chamber and an ink suitable for use in an ink-jet printer wherein the ink is in the chamber and the ink is as defined in the second, fourth or sixth aspects of the present invention. The cartridge may contain a high concentration ink and a low concentration ink, as described in the second aspect of the invention, in different chambers.

The invention is further illustrated by the following Examples in which all parts and percentages are by weight unless specified otherwise.

### EXAMPLE 1

### Preparation of

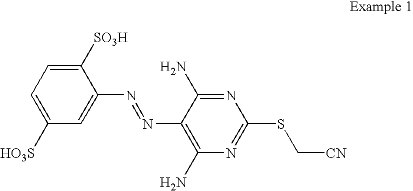

### Stage 1(a)

Preparation of (4,6-diaminopyrimidin-2-yl)thioacetonitrile

A suspension of 4,6-diamino-2-mercaptopyrimidine (0.2 mol, 28.4 g) and bromoacetonitrile (0.21 mol, 25.2 g) in ethanol (300 ml) was heated to reflux for 2 h during which time a clear brown solution formed. After this time HPLC analysis of the reaction mixture showed complete conversion to a new species (?ₘₐₓ=265 nm). The reaction mixture was allowed to cool to room temperature, concentrated in vacuo and the residue was suspended in water (500 ml) at pH 8-9 and heated to dissolve. This solution was then allowed to cool and the impure product was collected by filtration. This solid was dissolved in hot acetone (300 ml) and the solution was filtered to remove small amounts of residual starting material. The filtrate was concentrated in vacuo and the product recrystallised from water. The pure product was obtained as fine off-white crystals (32.4 g, 89.5%).

### Stage 2(b)

### Preparation of the Title Compound

2,5-Disulfoaniline (50 mmol, 16.2 g (78% strength)) was dissolved in water (200 ml) and cooled to 0-5° C. Concentrated hydrochloric acid (20 ml) was then added followed by the dropwise addition over 15 minutes of a 1M sodium nitrite solution (50 mmol, 50 ml). The solution was then stirred for 1 h to allow complete formation of the diazonium salt. After this time excess nitrous acid was quenched by the addition of sulfamic acid. Separately (4,6-diaminopyrimidin-2-yl)thioacetonitrile from Stage 1(a) was dissolved in a 2:1 ethanol:water mix (300 ml) and cooled to 0-5° C. The diazonium solution was then gradually added to this solution over the course of 20 minutes and the pH maintained at 4-5 by the addition of sodium acetate. The reaction mixture was allowed to warm to room temperature and then stirred for a further 4 h. The pH was then adjusted to approximately pH 3 with 2M HCl and the precipitated yellow solid isolated by filtration. HPLC analysis shows this yellow solid to be one species (?ₘₐₓ 398 nm). The dye was redissolved in water, dialysed to <100? and then dried at 60° C. to provide the pure product as a yellow solid (12.0 g, 49%).

### EXAMPLES 2 to 15

The compounds of Examples 2 to 7 were prepared according to the method of Example 1 except that (4,6-diaminopyrimidin-2-yl)thioacetonitrile was replaced with the compound shown in column 3 of Table 1. The final dye structure is shown in column 4 of Table 1.

The compounds of Examples 8 to 13 were prepared according to the method of Example 1 except that 2,5-disulfonaniline was replaced with the compound shown in column 2 of Table 1. The final dye structure is shown in column 4 of Table 1.

The compounds of Example 14 and 15 were prepared according to the method of Example 1 except that 2,5-disulfonaniline was replaced with the compound shown in column 2 of Table 1 and (4,6-diaminopyrimidin-2-yl)thioacetonitrile was replaced with the compound shown in column 3 of Table 1. The final dye structure is shown in column 4 of Table 1.

TABLE 1

| Exam- | | | |
|---|---|---|---|
| ple | A | B | Dye |
| 2 | 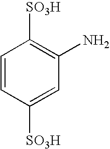 | 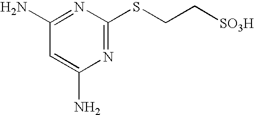 | 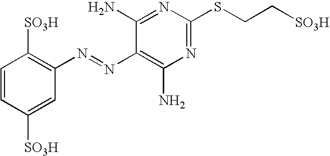 |
| 3 | 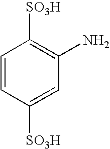 | 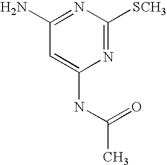 | 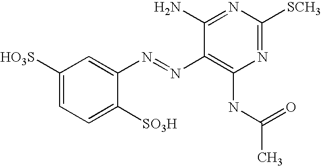 |
| 4 | 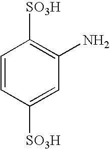 | 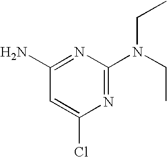 | 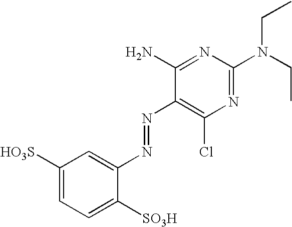 |
| 5 | 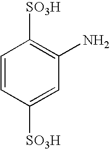 | 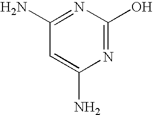 | 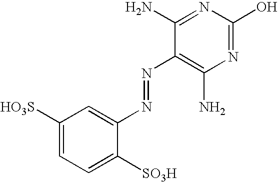 |
| 6 | 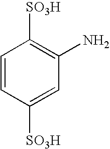 | 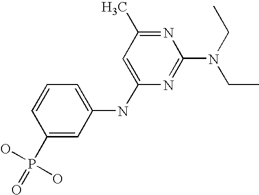 | 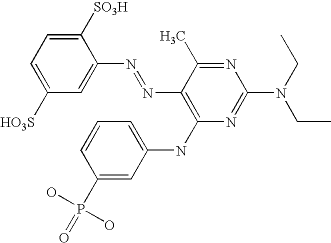 |
| 7 | 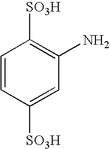 | 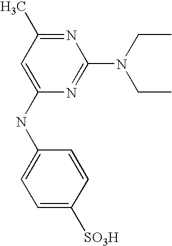 | 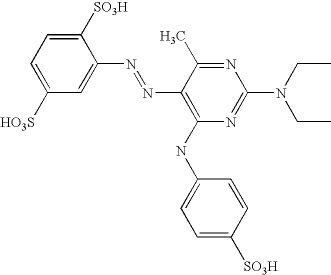 |
| 8 | 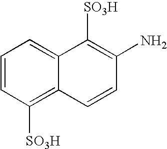 | 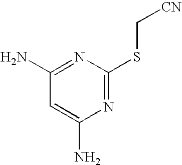 | 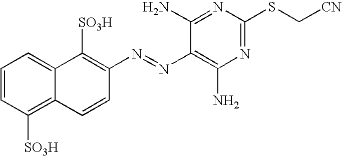 |
| 9 | 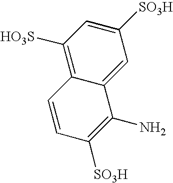 | 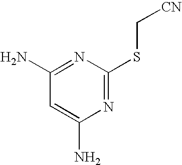 | 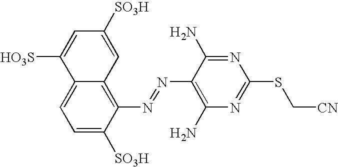 |
| 10 | 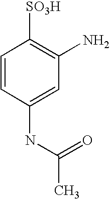 | 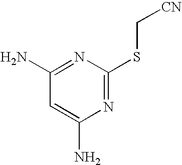 | 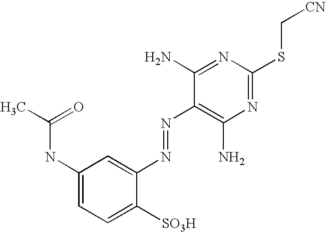 |
| 11 | 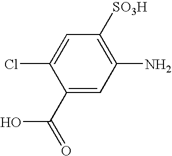 | 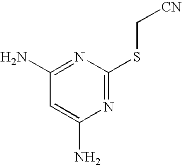 | 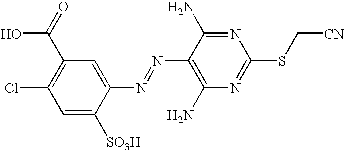 |
| 12 | 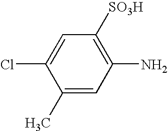 | 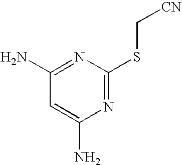 | 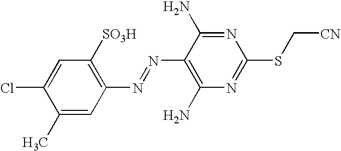 |
| 13 | 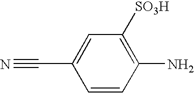 | 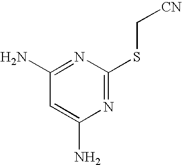 | 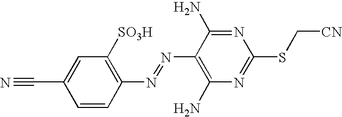 |
| 14 | 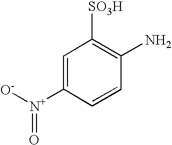 | 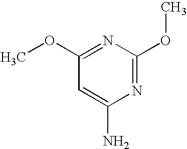 | 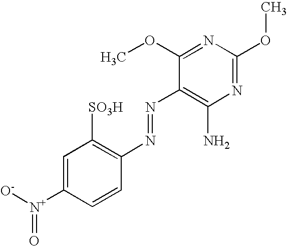 |
| 15 | 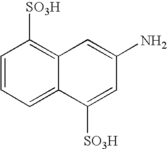 | 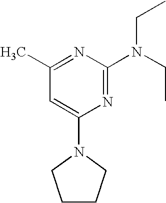 | 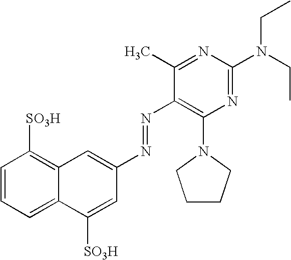 |

### EXAMPLE 16

### Preparation of:

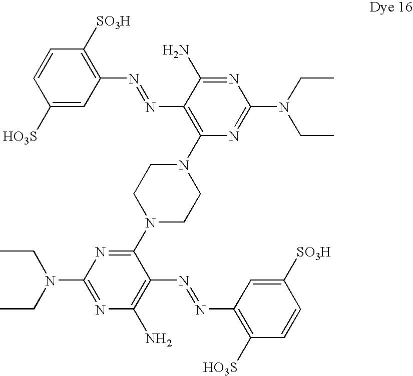

A solution of the compound of Example 4 (0.002 mol, 1.0 g) and piperazine (0.001 mol, 0.09 g) in water (25 ml) was stirred at reflux at pH 8 to 9, adjusting the pH with 2 m NaOH, for 1 h. The reaction mixture was allowed to cool and acidified with concentrated hydrochloric acid. The product that precipitated was collected by filtration, re-dissolved in water, dialysed to <100 μS and then dried at 60° C. to provide the pure product as a red solid (0.23 g, 24%).

### EXAMPLE 17

### Preparation of:

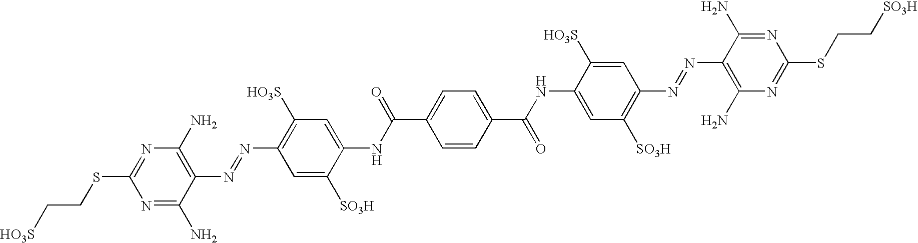

### Stage 17(a):

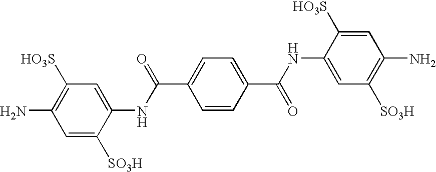

Sodium acetate (30 g) was added to a solution of 2,5-diaminobenzene-1,4-disulfonic acid (0.10 mol, 35 g) in water (200 ml) at pH 7, adjusting the pH with 2M NaOH. To this solution was added, in portions, terephthaloyl chloride (0.05 mol, 10.2 g). The reaction mixture was then stirred at room temperature for 16 hours. The product was collected by filtration, washed with a 5% sodium chloride solution (100 ml) and then dried to give 42.1 g (95%) of a grey solid (75% pure).

### Stage 17(b):

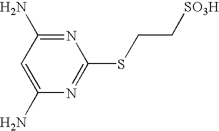

2-Bromoethanesulfonic acid (0.25 mol, 53.8 g) was added in portions over 1 hour to a mixture of 4,6-diamino-2-mercaptopyrimidine (0.2 mol, 28.7 g), methanol (400 ml) and 25% methanolic sodium methoxide (0.21 mol, 46 g) at reflux. The reaction mixture was then stirred at reflux for 16 hours and then allowing to cool to room temperature. The solid was collected by filtration and then dissolved in water (550 ml). The product was then precipitated by the addition of sodium chloride (120 g) and collected by filtration and dried at 60° C. to give 15.4 g (25%) of a grey solid (83% pure).

### Stage 17 (c): Preparation of the Title Compound

Sodium nitrite (0.02 mol, 1.5 g) was added to a solution of the product from Stage 17(a) (0.01 mol, 9.9 g) in water (100 ml). This solution was added dropwise to a mixture of concentrated hydrochloric acid (8 ml) and water (50 ml) at 0-5° C. The reaction mixture was stirred for 30 min at this temperature, excess nitrous acid was quenched by the addition of sulfamic acid and then a solution of the product from Stage 17(b) (0.022 mol, 7.2 g) in water (100 ml) was added at 0-5° C. The pH of the reaction mixture was adjusted to pH 4 to 5 by the addition of sodium acetate and then allowed to warm slowly to room temperature. The product was collected by filtration, re-dissolved in water, dialysed to <100 μS and then dried at 60° C. to provide the pure product as a red solid (10.0 g, 83%).

### EXAMPLE 18

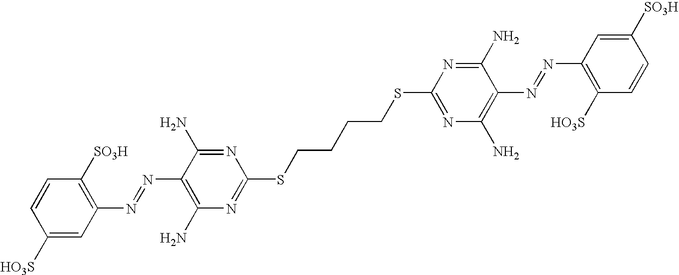

### Stage 18(a)

### Preparation of:

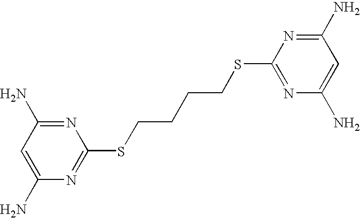

A suspension of 4,6-diamino-2-mercaptopyrimidine (0.2 mol, 28.4 g) and 1,4-dibromobutane (21.5 g, 0.1 mol) in ethanol (200 ml) was heated at reflux for 24 h. The reaction mixture was allowed to cool to room temperature, the solid filtered off and stirred in water (1000 ml) at pH 10 toll, adjusting the pH with 2M NaOH, for 1 hour. The product was filtered off and recrystallised from 1-methyl-2-pyrrolidinone (200 ml) to give 23.6 g of a cream solid (70%).

### Stage 18 (b)

### Preparation of the Title Compound

The title compound was prepared according to the method of Example 1, wherein (4,6-diaminopyrimidin-2-yl)thioacetonitrile is replaced with the product from Stage 18(a) (0.5 equivalent).

### EXAMPLE 19

### Preparation of:

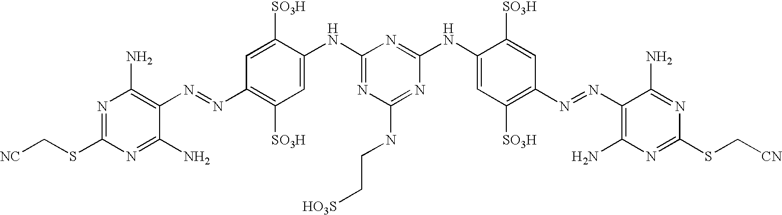

### Stage 19(a):

### Preparation of:

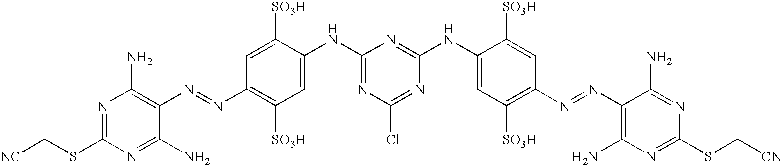

A solution of 2,5-diaminobenzene-1,4-disulfonic acid (0.02 mol, 7.0 g) in water (25 ml) was added to a suspension of cyanuric chloride (0.01 mol, 1.9 g) in a mixture of water (50 ml) and acetone (15 ml) at 0-5° C. The reaction mixture was stirred at 0-5° C. for 2 hours and then for 10 hours at 30-40° C. The pH of the reaction was maintained at pH 6 to 7 by the addition of 2N sodium hydroxide solution for the duration of the reaction. The reaction mixture was cooled to 0-5° C. and concentrated hydrochloric acid (12 ml) was added followed by the dropwise addition of a solution of sodium nitrite (0.02 mol, 1.4 g) in water (10 ml). The reaction mixture was stirred for 1 hour at 0-5° C., excess nitrous acid was quenched by the addition of sulfamic acid and then a solution of the product from example 1 stage (a) (0.022 mol, 3.8 g) in a mixture of water (75 ml) and 1-methyl-2-pyrrolidinone (50 ml) was added at 0-5° C. The pH of the reaction mixture was maintained at pH 4 to 5 by the addition of sodium acetate and the reaction mixture was allowed to warm to room temperature over 16 hours. The product was collected by filtration, re-dissolved in water (300 ml), dialysed to <100 μS and then evaporated under reduced pressure to provide a red solid (6.4 g, 62%).

### Stage 19 (b):

### Preparation of the Title Compound

A solution of taurine (0.01 mol, 1.3 g) in water (50 ml) was added to a solution of the product from stage 19(a) (0.003 mol, 4.2 g) in water (150 ml). The reaction mixture was stirred at 60° C. and pH 8-9 (adjusting with 2M sodium hydroxide) for 2 hours. Sodium chloride (20 g) was added to the reaction mixture which was allowed to cool to room temperature. The precipitated product was collected by filtration, dissolved in water (150 ml), dialysed to <100 μS and then dried at 60° C. to give 3.5 g (31%) of an orange solid.

### COMPARATIVE EXAMPLE

### Preparation of:

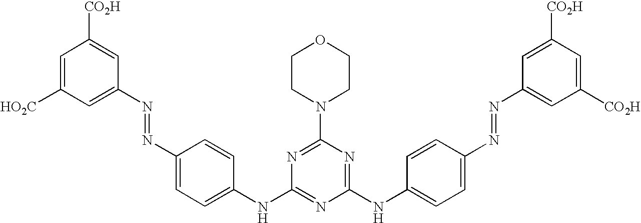

The dye of the Comparative Example was prepared as described in Example 10 of U.S. Pat. No. 5,347,301.

### EXAMPLE 17

### Preparation of the Example Inks and the Comparative Ink

Inks according to the invention and a Comparative Ink were prepared by dissolving 3 g of the dyes of Examples 1, 4, 17 and 19 or the dye of the Comparative Example in 97 ml of a liquid medium consisting of 5 parts 2-pyrrolidone; 5 parts thiodiethylene glycol; 1 part Surfynol™ 465 and 89 parts water and adjusting the pH to between pH 8 to 9 with sodium hydroxide. Surfynol™ 465 is a surfactant from Air Products. The resultant inks are Example Inks 1, 4, 17 and 19 and the Comparative Example Ink.

### EXAMPLE 18

### Ink-let Printing

The Example Inks and the Comparative Ink, prepared as described above, were then filtered through a 0.45 micron nylon filter and incorporated into empty print cartridges using a syringe.

These inks were printed (at 100%) using an ink-jet printer onto Epson Premium Glossy Photo Paper (SEC PM).

### Print Evaluation

The chroma intensity of the resultant prints was measured using a Gretag spectrolino spectrophotometer set to the following parameters:

Measuring Geometry: 0°/45°

Spectral Range: 380-730 nm

Spectral Interval: 10 nm

Illuminant: D65

Observer: 2° (CIE 1931)

Density: Ansi A

External Filler: None.

The chroma intensity of the prints obtained are shown below.

| Print of | Chroma Intensity at 100% print |
|---|---|
| Example Ink 1 | 83 |
| Example Ink 4 | 85 |
| Example Ink 17 | 120 |
| Example Ink 19 | 120 |
| Comparative Example Ink | 76 |

Clearly inks according to the present invention yielded prints with an enhanced chroma.

### Further Inks

Further inks may be prepared according to Tables A and B wherein the dye described in the first column is the dye made in the above example of the same number. Numbers quoted in the second column onwards refer to the number of parts of the relevant ingredient and all parts are by weight. The inks may be applied to paper by thermal or piezo ink-jet printing.

The following abbreviations are used in Tables A and B:

PG=propylene glycol

DEG=diethylene glycol

NMP=N-methylpyrrolidone

DMK=dimethylketone

IPA=isopropanol

MeOH=methanol

2P=2-pyrrolidone

MIBK=methylisobutyl ketone

P12=propane-1,2-diol

BDL=butane-2,3-diol

CET=cetyl ammonium bromide

PHO=Na₂HPO₄ and

TBT=tertiary butanol

TDG=thiodiglycol

TABLE A

| | Dye | | | | | | | Na | | | | |
|---|---|---|---|---|---|---|---|---|---|---|---|---|
| Example | Content | Water | PG | DEG | NMP | DMK | NaOH | Stearate | IPA | MEOH | 2P | MIBK |
| 1 | 2.0 | 80 | 5 | | 6 | 4 | | | | | 5 | |
| 2 | 3.0 | 90 | | 5 | 5 | | 0.2 | | | | | |
| 3 | 10.0 | 85 | 3 | | 3 | 3 | | | | 5 | 1 | |
| 4 | 2.1 | 91 | | 8 | | | | | | | | 1 |
| 5 | 3.1 | 86 | 5 | | | | | 0.2 | 4 | | | 5 |
| 6 | 1.1 | 81 | | | 9 | | 0.5 | 0.5 | | | 9 | |
| 7 | 2.5 | 60 | 4 | 15 | 3 | 3 | | | 6 | 10 | 5 | 4 |
| 8 | 5 | 65 | | 20 | | | | | 10 | | | |
| 9 | 2.4 | 75 | 5 | 4 | | 5 | | | | 6 | | 5 |
| 10 | 4.1 | 80 | 3 | 5 | 2 | 10 | | 0.3 | | | | |
| 11 | 3.2 | 65 | | 5 | 4 | 6 | | | 5 | 4 | 6 | 5 |
| 12 | 5.1 | 96 | | | | | | | | 4 | | |
| 13 | 10.8 | 90 | 5 | | | | | | 5 | | | |
| 14 | 10.0 | 80 | 2 | 6 | 2 | 5 | | | 1 | | 4 | |
| 15 | 1.8 | 80 | | 5 | | | | | | | 15 | |
| 16 | 2.6 | 84 | | | 11 | | | | | | 5 | |
| 17 | 3.3 | 80 | 2 | | | 10 | | | | 2 | | 6 |
| 18 | 12.0 | 90 | | | | 7 | 0.3 | | 3 | | | |
| 19 | 5.4 | 69 | 2 | 20 | 2 | 1 | | | | | 3 | 3 |
| 1 | 6.0 | 91 | | | 4 | | | | | | 5 | |

TABLE B

| | Dye | | | | | | | | | | | |
|---|---|---|---|---|---|---|---|---|---|---|---|---|
| Example | Content | Water | PG | DEG | NMP | CET | TBT | TDG | BDL | PHO | 2P | PI2 |
| 1 | 3.0 | 80 | 15 | | | 0.2 | | | | | 5 | |
| 2 | 9.0 | 90 | | 5 | | | | | | 1.2 | | 5 |
| 3 | 1.5 | 85 | 5 | 5 | | 0.15 | 5.0 | 0.2 | | | | |
| 4 | 2.5 | 90 | | 6 | 4 | | | | | 0.12 | | |
| 5 | 3.1 | 82 | 4 | 8 | | 0.3 | | | | | | 6 |
| 6 | 0.9 | 85 | | 10 | | | | | 5 | 0.2 | | |
| 7 | 8.0 | 90 | | 5 | 5 | | | 0.3 | | | | |
| 8 | 4.0 | 70 | | 10 | 4 | | | | 1 | | 4 | 11 |
| 9 | 2.2 | 75 | 4 | 10 | 3 | | | | 2 | | 6 | |
| 10 | 10.0 | 91 | | | 6 | | | | | | 3 | |
| 11 | 9.0 | 76 | | 9 | 7 | | 3.0 | | | 0.95 | 5 | |
| 12 | 5.0 | 78 | 5 | 11 | | | | | | | 6 | |
| 13 | 5.4 | 86 | | | 7 | | | | | | 7 | |
| 14 | 2.1 | 70 | 5 | 5 | 5 | 0.1 | 0.2 | 0.1 | 5 | 0.1 | 5 | |
| 15 | 2.0 | 90 | | 10 | | | | | | | | |
| 16 | 2 | 88 | | | | | | 10 | | | | |
| 17 | 5 | 78 | | | 5 | | | 12 | | | 5 | |
| 18 | 8 | 70 | 2 | | 8 | | | 15 | | | 5 | |
| 19 | 10 | 80 | | | | | | 8 | | | 12 | |
| 1 | 10 | 80 | | 10 | | | | | | | | |

1. A process for printing an image on a substrate by means of an ink-jet printer which comprises applying thereto a composition comprising a liquid medium and a mono-azo compound of Formula (1), and salts thereof, or a dimer of said mono-azo compound of Formula (2), and salts thereof: 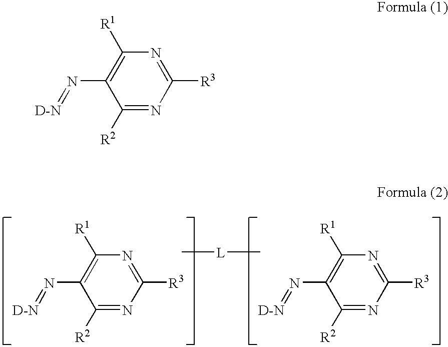
wherein:
D is an optionally substituted aryl or an optionally substituted heteroaryl group;
R¹ and R² are each independently optionally substituted alkyl: halo: amino: —NR⁴R⁵; wherein R⁴ is H, optionally substituted alkyl, optionally substituted alkoxy, optionally substituted acyl, optionally substituted aryl, optionally substituted heterocyclyl; and R⁵ is optionally substituted alkyl, optionally substituted alkoxy, optionally substituted acyl, optionally substituted aryl, optionally substituted heterocyclyl or R⁴ together with R⁵ and the nitrogen to which they are attached forms an optionally substituted 5 or 6 membered ring: —OR⁶; wherein R⁶ is H, optionally substituted alkyl: or —SR⁷; wherein R⁷ is optionally substituted alkyl;
R³ is amino: halo; —NR⁴R⁵; wherein R⁴ is H, optionally substituted alkyl, optionally substituted alkoxy, optionally substituted acyl, optionally substituted aryl, optionally substituted heterocyclyl; and R⁵ is optionally substituted alkyl, optionally substituted alkoxy, optionally substituted acyl, optionally substituted aryl, optionally substituted heterocyclyl or R⁴ together with R⁵ and the nitrogen to which they are attached forms an optionally substituted 5 or 6 membered ring: hydroxy: —OR⁶; wherein R⁶ is H, optionally substituted alkyl: or —SR⁷; wherein R⁷ is optionally substituted alkyl; and
L is a divalent linking group that is covalently attached to D, R¹ or R³.

2. A process according to claim 1 wherein the compound of Formula (2), and salts thereof, is of Formulae, (3) to (5), and salts thereof: 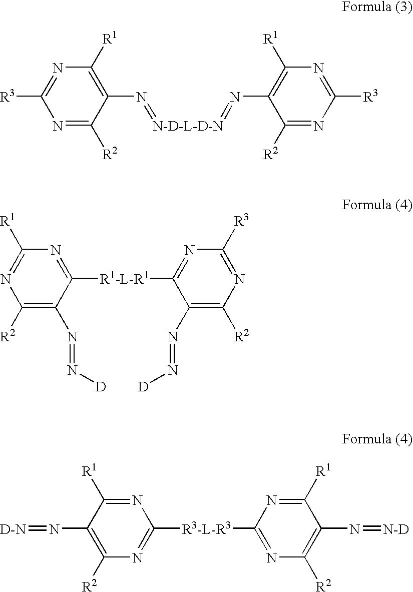
wherein D, L, R¹, R² and R³ are as defined in claim 1.

3.-13. (canceled)

14. A composition comprising a compound of Formula (1) and salts thereof or Formula (2) and salts thereof as defined in claim 2 and a liquid medium which comprises a mixture of water and organic solvent or organic solvent free from water.

15. A composition according to claim 14 that is ink suitable for use in an ink-jet printer.

16. A mono-azo compound of Formula (1) and salts thereof: 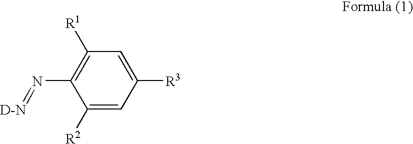
wherein:
D is an optionally substituted aryl or an optionally substituted heteroaryl group;
R¹ and R² are each independently optionally substituted alkyl: halo: amino:
—NR⁴R⁵; wherein R⁴ is H, optionally substituted alkyl, optionally substituted alkoxy, optionally substituted acyl, optionally substituted aryl, optionally substituted heterocyclyl; and R⁵ is optionally substituted alkyl, optionally substituted alkoxy, optionally substituted acyl, optionally substituted aryl, optionally substituted heterocyclyl or R⁴ together with R⁵ and the nitrogen to which they are attached forms an optionally substituted 5 or 6 membered ring: —OR⁶; wherein R⁶ is H or optionally substituted alkyl: or —SR⁷; wherein R⁷ is optionally substituted alkyl;
R³ is amino: halo; —NR⁴R⁵; wherein R⁴ is H, optionally substituted alkyl, optionally substituted alkoxy, optionally substituted acyl, optionally substituted aryl, optionally substituted heterocyclyl; and R⁵ is optionally substituted alkyl, optionally substituted alkoxy, optionally substituted acyl, optionally substituted aryl, optionally substituted heterocyclyl or R⁴ together with R⁵ and the nitrogen to which they are attached forms an optionally substituted 5 or 6 membered ring: hydroxy: —OR⁶; wherein R⁶ is H or optionally substituted alkyl: or —SR⁷; wherein R⁷ is optionally substituted alkyl; and
provided that the compound and salts thereof of Formula (1) is free from fibre reactive groups.

17. A mono-azo compound and salts thereof according to claim 16 wherein when D is optionally substituted aryl it is optionally substituted phenyl or optionally substituted napthyl.

18. A mono-azo compound and salts thereof according to claim 16 wherein when D is optionally substituted heteroaryl it is selected from the group consisting of the following: optionally substituted pyrrolyl, optionally substituted furyl, optionally substituted thienyl, optionally substituted pyrazolyl, optionally substituted imidazolyl, optionally substituted triazolyl, optionally substituted thiazolyl, optionally substituted thiadiazolyl, optionally substituted pyridyl, optionally substituted pyrimidyl or optionally substituted pyrazinyl.

19. A mono-azo compound and salts thereof according to claim 16 wherein D carries at least one group selected from —SO₃H, —CO₂H or —PO₃H₂.

20. A mono-azo compound and salts thereof according to claim 16 wherein D is 2,5-disulfophenyl, 1,3,6-trisulfo-7-naphthyl, 2-sulfo-4-methoxyphenyl or 4-sulfophenyl.

21. A mono-azo compound and salts thereof according to claim 16 wherein R¹ and R² are each independently: chloro; amino; NHR⁵ wherein R⁵ is optionally substituted C₁₋₄alkyl, optionally substituted C₁₋₄ acyl, phenyl substituted with at least one substituent selected from the group consisting of —SO₃H and —CO₂H or —OR⁶; wherein R⁶ is H or optionally substituted C₁₋₄alkyl.

22. A mono-azo compound and salts thereof according to claim 16 wherein R³ is amino; —NR⁴R⁵, wherein R⁴ is H or optionally substituted C₁₋₄alkyl and R⁵ is optionally substituted C₁₋₄alkyl; —OR⁶, wherein R⁶ is H or optionally substituted C₁₋₄alkyl; or —SR¹, wherein R⁷ is optionally substituted C₁₋₄alkyl.

23. A composition comprising a compound of Formula (1) and salts thereof as defined in claim 16 and water.

24. A dimer of mono-azo compounds of Formula (2) and salts thereof: 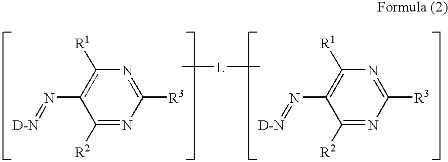
wherein:
D is an optionally substituted aryl or an optionally substituted heteroaryl group;
R¹ and R² are each independently optionally substituted alkyl: halo: amino: —NR⁴R⁵; wherein R⁴ is H, optionally substituted alkyl, optionally substituted alkoxy, optionally substituted acyl, optionally substituted aryl, optionally substituted heterocyclyl; and R⁵ is optionally substituted alkyl, optionally substituted alkoxy, optionally substituted acyl, optionally substituted aryl, optionally substituted heterocyclyl or R⁴ together with R⁵ and the nitrogen to which they are attached forms an optionally substituted 5 or 6 membered ring: —OR⁶; wherein R⁶ is H or optionally substituted alkyl: or —SR⁷; wherein R⁷ is optionally substituted alkyl;
R³ is amino: halo; —NR⁴R⁵; wherein R⁴ is H, optionally substituted alkyl, optionally substituted alkoxy, optionally substituted acyl, optionally substituted aryl, optionally substituted heterocyclyl; and R⁵ is optionally substituted alkyl, optionally substituted alkoxy, optionally substituted acyl, optionally substituted aryl, optionally substituted heterocyclyl or R⁴ together with R⁵ and the nitrogen to which they are attached forms an optionally substituted 5 or 6 membered ring: hydroxy: —OR⁶; wherein R⁶ is H or optionally substituted alkyl: or —SR⁷; wherein R⁷ is optionally substituted alkyl; and
L is a divalent linking group that is covalently attached to D, R¹ or R³.

25. A dimer according to claim 24 where the compound of Formula (2) and salts thereof is of Formulae, (3) to (5) and salts thereof: 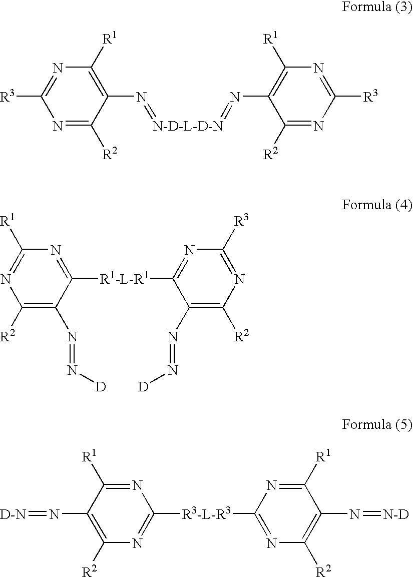
wherein D, L, R¹, R² and R³ are as defined in claim 24.

26. A dimmer and salts thereof according to claim 24 wherein when D is optionally substituted aryl it is optionally substituted phenyl or optionally substituted napthyl or when D is bound to the linking group, L, it is the equivalent divalent radical.

27. A dimmer and salts thereof according to claim 24 wherein when D is optionally substituted heteroaryl it is selected from the group consisting of the following: optionally substituted pyrrolyl, optionally substituted furyl, optionally substituted thienyl, optionally substituted pyrazolyl, optionally substituted imidazolyl, optionally substituted triazolyl, optionally substituted thiazolyl, optionally substituted thiadiazolyl, optionally substituted pyridyl, optionally substituted pyrimidyl or optionally substituted pyrazinyl or when D is bound to the linking group, L, it is the equivalent divalent radical.

28. A dimmer and salts thereof according to claim 24 wherein D carries at least one group selected from —SO₃H, —CO₂H or —PO₃H₂.

29. A dimmer and salts thereof according to claim 24 wherein D is 2,5-disulfophenyl, 1,3,6-trisulfo-7-naphthyl, 2-sulfo-4-methoxyphenyl or 4-sulfophenyl or when D is bound to the linking group, L, it is the equivalent divalent radical.

30. A dimmer and salts thereof according to claim 24 wherein R¹ and R² are each independently: chloro; amino; NHR⁵ wherein R⁵ is optionally substituted C₁₋₄alkyl, optionally substituted C₁₋₄ acyl, phenyl substituted with at least one substituent selected from the group consisting of —SO₃H and —CO₂H or —OR⁶; wherein R⁶ is H or optionally substituted C₁₋₄alkyl or when R¹ is bound to the linking group, L, it is the equivalent divalent radical.

31. A dimmer and salts thereof according to claim 24 wherein R³ is amino; —NR⁴R⁵, wherein R⁴ is H or optionally substituted C₁₋₄ alkyl and R⁵ is optionally substituted C₁₋₄alkyl; —OR⁶, wherein R⁶ is H or optionally substituted C₁₋₄ alkyl; or —SR¹, wherein R⁷ is optionally substituted C₁₋₄alkyl or when R³ is bound to the linking group, L, it is the equivalent divalent radical.

32. A dimmer and salts thereof according to claim 24 wherein L is selected from the group consisting of: optionally substituted alkylene; optionally substituted arylene; optionally substituted cycloalkenylene, and optionally substituted heterocyclylene (including optionally substituted heteroarylene); —CO—; —NHCONH—; a group of formula: —CO—R⁹—CO—; —CO—NH—R⁹—NH—CO—; —SO₂—R⁹—SO₂—; —SO₂—NH—R⁹—NH—SO₂—; or —NR¹⁰—R⁹—NR¹⁰—; wherein R⁹ is alkylene or arylene optionally bearing substituents selected from the group consisting of alkoxy, sulfo, carboxy, hydroxy and amino and R¹⁰ is H, alkyl, aryl or heterocyclyl optionally bearing a substituent selected from the group comprising alkoxy, sulfo, carboxy, hydroxy and amino.

33. A dimmer and salts thereof according to claim 24 wherein L comprises one or more groups of formula: 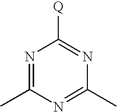
wherein: Q is NR¹¹R¹², SR¹¹ or OR¹¹ and R¹¹ and R¹² are independently H, optionally substituted alkyl, optionally substituted aryl or optionally substituted heterocyclyl where the substituent is selected from the group consisting of alkoxy, amino, sulfo, carboxy, hydroxy and amino.

34. A dimmer and salts thereof according to claim 24 wherein the compounds of Formula (2) and salts thereof are free from fibre reactive groups.

35. A composition comprising a compound of Formula (2) and salts thereof as defined in claim 24 and water.

36. A material printed with a compound and salts thereof as described in claim 16 or claim 24.

37. A material according to claim 36 that is a print on a photographic quality paper printed by means of a process as described in claims 1 to 13 claim 1.

38. An ink-jet printer cartridge comprising a chamber and an ink suitable for use in an ink-jet printer wherein the ink is in the chamber and the ink is as defined in claim 15.
